(19) United States
(12) Patent Application Publication
(10) Pub. No.: US 2014/0207833 A1
(43) Pub. Date: Jul. 24, 2014

(54) FILE OPENING METHOD, APPARATUS, AND TERMINAL

(71) Applicants: Fei Xie, Shenzhen (CN); Xiaoming Gao, Shenzhen (CN); Jinsong Ma, Shenzhen (CN); Guize Liu, Shenzhen (CN)

(72) Inventors: Fei Xie, Shenzhen (CN); Xiaoming Gao, Shenzhen (CN); Jinsong Ma, Shenzhen (CN); Guize Liu, Shenzhen (CN)

(73) Assignee: TENCENT TECHNOLOGY (SHENZHEN) COMPANY LIMITED, Shenzhen (CN)

(21) Appl. No.: 14/342,482

(22) PCT Filed: Jun. 14, 2012
(86) PCT No.: PCT/CN2012/076874

§ 371 Date: Mar. 4, 2014

(30) Foreign Application Priority Data
Sep. 5, 2011 (CN) 201110260036.X

(51) Int. Cl. G06F 17/30

(52) U.S. Cl. CPC G06F 17/30067
USPC 707/822

(57) ABSTRACT

The present disclosure, pertaining to the field of data processing technologies, discloses a file opening method, apparatus, and terminal. The method includes: capturing a file opening action, and acquiring a corresponding original file system device object and a corresponding original file system distribution function address; and directly sending a file opening request to a file system where the original file system device object is located, transferring the file opening request over the file system to an original file system distribution function corresponding to the original file system distribution function address, and performing a file opening operation by using the original file system distribution function. According to the present disclosure, a file opening request is directly sent to a file system where an original file system device object is located, and a file opening operation is performed by using an original file system distribution function.

This application claims priority to Chinese Patent Application No. 201110260036.X, filed before Chinese Patent Office on Sep. 5, 2011 and entitled “FILE OPENING METHOD, APPARATUS, AND TERMINAL”, which is incorporated herein by reference in its entirety.

### TECHNICAL FIELD

The present disclosure relates to the field of data processing technologies, and in particular, to a file opening method, apparatus, and terminal.

### BACKGROUND

With rapid development of the network technologies, and constant increase of data amount, the number of various electronic files storing information is increasing. Regardless of in daily leisure and entertainment or in busy work, various files are inevitably involved or used. Therefore, it is almost a routine practice for people to open files every day.

A conventional file opening method is implemented by a commonly used Windows application programming interface (API) mechanism, and the file opening operation may be captured and controlled by a file filter driver. The file filter driver is a type of Windows driver program, which is installed on a file system to capture system's access to a file and provide such functions as filter control. On a machine installed with antivirus software, once a file opening action is captured by the file filter driver, virus scanning is activated.

During the implementation of the present disclosure, the inventors find that the prior art has at least the following problems:

According to the conventional file opening method, the virus scanning activated once a file is opened is mostly unnecessary, which further increases system load; in addition, when multiple types of antivirus software are installed, once a file of one type of antivirus software is opened, another type of antivirus software is triggered to performing virus scanning, and once the scanned file is opened, still another type of antivirus software is further activated to performing virus scanning again, thereby causing repeated opening of the file, and further resulting in a compatibility problem.

### SUMMARY

To improve system compatibility while opening a file, and reduce system load, embodiments of the present disclosure provide a file opening method, apparatus, and terminal. The technical solutions are as follows:

In one aspect, a file opening method is provided, where the method includes:

capturing a file opening action, and acquiring a corresponding original file system device object and a corresponding original file system distribution function address; and

directly sending a file opening request to a file system where the original file system device object is located, transferring the file opening request over the file system to an original file system distribution function corresponding to the original file system distribution function address, and performing a file opening operation by using the original file system distribution function.

Furthermore, prior to the capturing a file opening action, the method further includes:

searching for an import table of 32-bit dynamic link library files and replacing a function address stored in the import table with a preset function address;

where correspondingly, the performing a file opening operation by using the original file system distribution function specifically includes:

performing the file opening operation by using the original file system distribution function according to the preset function address replacing the original one.

Furthermore, after the capturing a file opening action, the method further includes:

recording a parameter corresponding to the file opening action;

where correspondingly, the performing a file opening operation by using the original file system distribution function specifically includes:

performing the file opening operation by using the original file system distribution function according to the recorded parameter.

The acquiring a corresponding original file system device object specifically includes:

by using a pre-written driver program, searching for the corresponding original file system device object in a volume parameter block (VPB) structure recording file system device objects.

The acquiring a corresponding original file system distribution function address specifically includes:

starting a pre-written driver program in a BOOT manner, and acquiring the corresponding original file system distribution function address by using the pre-written driver program.

The directly sending a file opening request to a file system where the original file system device object is located specifically includes:

using function IoCreateFileSpecifyDeviceObjectHint, and by using the original file system device object as a parameter, directly sending the file opening request to the file system where the original file system device object is located.

In another aspect, a file opening apparatus is provided, where the apparatus includes:

a capturing module, configured to capture a file opening action;

a first acquiring module, configured to acquire a corresponding original file system device object after the capturing module captures the file opening action;

a second acquiring module, configured to acquire a corresponding original file system distribution function address after the capturing module captures the file opening action;

a sending module, configured to directly send a file opening request to a file system where the original file system device object acquired by the first acquiring module is located, and transfer the file opening request over the file system to an original file system distribution function corresponding to the original file system distribution function address acquired by the second acquiring module; and

an opening module, configured to perform a file opening operation by using the original file system distribution function.

Furthermore, the apparatus further includes:

a replacing module, configured to search for an import table of 32-bit dynamic link library files and replace a function address stored in the import table with a preset function address;

where correspondingly, the opening module is specifically configured to perform the file opening operation by using the original file system distribution function according to the preset function address replacing the original one by the replacing module.

Furthermore, the apparatus further includes:

a recording module, configured to record a parameter corresponding to the file opening action captured by the capturing module; and

where correspondingly, the opening module is specifically configured to perform the file opening operation by using the original file system distribution function according to the parameter recorded by the recording module.

The first acquiring module is specifically configured to, by using a pre-written driver program, search for the corresponding original file system device object in a VPB structure recording file system device objects.

The second acquiring module is specifically configured to start a pre-written driver program in a BOOT manner, and acquire the corresponding original file system distribution function address by using the pre-written driver program.

The sending module is specifically configured to use function IoCreateFileSpecifyDeviceObjectHint, and by using the original file system device object as a parameter, directly send the file opening request to the file system where the original file system device object is located.

In yet another aspect, a terminal is provided, where the terminal includes any file opening apparatus as described above.

The technical solutions provided in the embodiments of the present disclosure achieve the following beneficial effects:

A file opening action is captured, a file opening request is directly sent to a file system where an original file system device object is located, and a file opening operation is performed by using an original file system distribution function. This implements pass-through of a file filter driver, and thus reduces unnecessary operations of virus scanning each time a file is opened. In addition, when multiple types of antivirus software are installed, system load caused by scanning due to repeated opening of files is decreased, and the system compatibility is thus further improved.

### BRIEF DESCRIPTION OF THE DRAWINGS

For a better understanding of the technical solutions in the embodiments of the present disclosure, the accompanying drawings for illustrating the embodiments are briefly described below. Apparently, the accompanying drawings in the following description illustrate only some embodiments of the present disclosure, and persons of ordinary skill in the art can derive other accompanying drawings from these accompanying drawings without any creative efforts.

FIG. 1 is a flowchart of a file opening method according to an embodiment of the present disclosure;

FIG. 2 is a flowchart of a file opening method according to an embodiment of the present disclosure;

FIG. 3 is a flowchart of a pass-through process during file opening according to an embodiment of the present disclosure;

FIG. 4 is a schematic structural diagram of a file opening apparatus according to an embodiment of the present disclosure;

FIG. 5 is a schematic structural diagram of another file opening apparatus according to an embodiment of the present disclosure; and

FIG. 6 is a schematic structural diagram of still another file opening apparatus according to an embodiment of the present disclosure.

### DETAILED DESCRIPTION

To make the objectives, technical solutions, and advantages of the present disclosure clearer, the embodiments of the present disclosure are described in detail below with reference to the accompanying drawings.

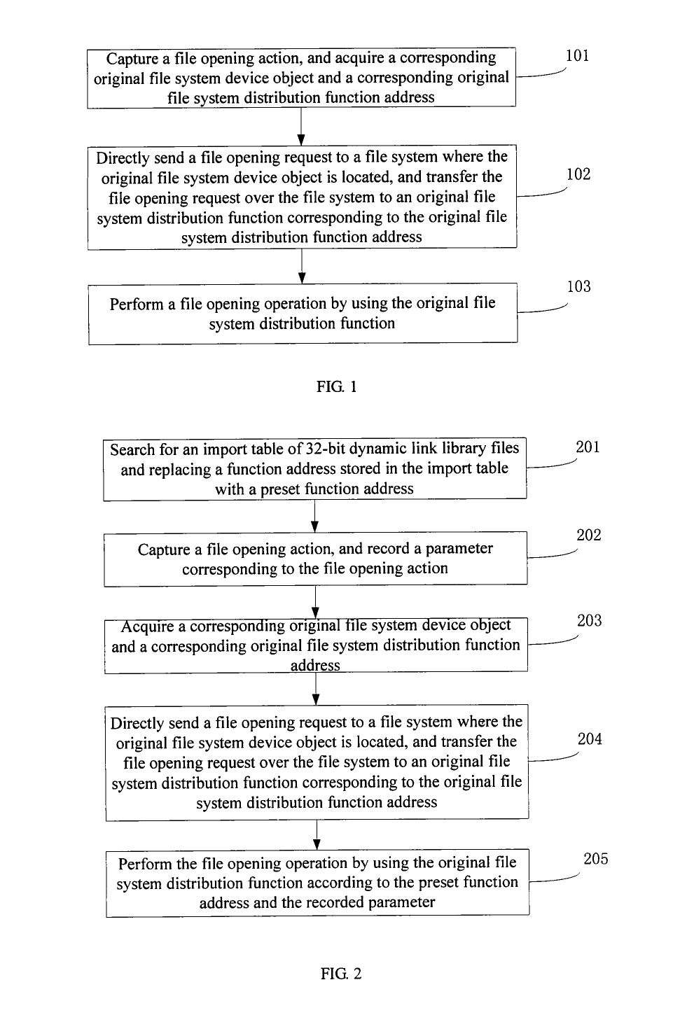

According to the conventional file opening method, a file opening action is captured and controlled by a file filter driver, thereby activating virus scanning. Such operation not only increases system load, but also causes a compatibility problem between multiple types of antivirus software. Accordingly, this embodiment provides a file opening method. According to the method, a file filter driver in an original file opening manner is passed through, and a file opening request is directly sent to a file system to perform a file opening operation. This reduces system load caused by control of the file filter driver, and further improves system compatibility. Referring to FIG. 1, the method provided in this embodiment includes the following steps:

101: capturing a file opening action, and acquiring a corresponding original file system device object and a corresponding original file system distribution function address; and

102: directly sending a file opening request to a file system where the original file system device object is located, and transferring the file opening request over the file system to an original file system distribution function corresponding to the original file system distribution function address;

103: performing a file opening operation by using the original file system distribution function.

Furthermore, prior to the capturing a file opening action, the method further includes:

searching for an import table of 32-bit dynamic link library files and replacing a function address stored in the import table with a preset function address;

where correspondingly, the performing a file opening operation by using the original file system distribution function specifically includes:

performing the file opening operation by using the original file system distribution function according to the preset function address replacing the original one.

The import table of 32-bit dynamic link library files records a system API function address that is required by an executable file. The API function address is a function address stored in the import table, for example, addresses of functions of NtCreateFile and NtOpenFile. The function address stored in the import table is replaced with the preset function address, such that before the file filter driver captures and controls the file opening operation, the file filter driver is passed through so as to directly transfer the file opening request to the file system where the original file system device object is located, and perform the file opening operation by using the original file system distribution function. This prevents unnecessary operations of virus scanning each time a file is opened, and also avoids the problems of increased system load and compatibility caused by virus scanning due to repeated opening of files when multiple types of antivirus software are installed. In specific implementation, the address of the preset function MyNtCreateFile or another preset function may be used to replace a function address stored in the import table. This embodiment sets no limitation on the specific preset function address, and any function address that can be used to pass through the file filter driver is applicable.

Furthermore, prior to the capturing a file opening action, the method further includes:

recording a parameter corresponding to the file opening action;

where correspondingly, the performing a file opening operation by using the original file system distribution function specifically includes:

performing the file opening operation by using the original file system distribution function according to the recorded parameter.

The acquiring a corresponding original file system device object specifically includes:

by using a pre-written driver program, searching for the corresponding original file system device object in a VPB structure recording file system device objects.

The acquiring a corresponding original file system distribution function address specifically includes:

starting a pre-written driver program in a BOOT manner, and acquiring the corresponding original file system distribution function address by using the pre-written driver program.

The directly sending a file opening request to a file system where the original file system device object is located specifically includes:

using function IoCreateFileSpecifyDeviceObjectHint, and by using the original file system device object as a parameter, directly sending the file opening request to the file system where the original file system device object is located.

According to the method provided in this embodiment, a file opening action is captured, a file opening request is directly sent to a file system where an original file system device object is located, and a file opening operation is performed by using an original file system distribution function. This implements pass-through of a file filter driver, and thus reduces unnecessary operations of virus scanning each time a file is opened. In addition, when multiple types of antivirus software are installed, system load caused by scanning due to repeated opening of files is decreased, and the system compatibility is thus further improved.

For a detailed description of the method provided in this embodiment, the above-described embodiment is used as an example to illustrate the method. For details, reference may be made to the above-described embodiment.

This embodiment provides a file opening method. According to the method, a file filter driver in an original file opening manner is passed through, and a file opening request is directly sent to a file system to perform a file opening operation. This reduces system load caused by control of the file filter driver, and further improves system compatibility. Referring to FIG. 2, the method provided in this embodiment includes the following steps:

201: Searching for an import table of 32-bit dynamic link library files and replacing a function address stored in the import table with a preset function address.

The import table of 32-bit dynamic link library files is an import table of kernel32.dll required by the executable file, in which addresses of system API functions that are needed for files are recorded. The process of searching for the import table of 32-bit dynamic link library files and replacing the function address stored in the import table with the preset function address is a process of implementing hook. By performing hook on the Ring application layer, such operations as file opening can be controlled first, such that after the address replacement, when the original function is called, the process proceeds with the preset function replacing the original one. This embodiment sets no limitation on the original function address stored in the import table and the function address replacing the original one. The hooked function may be such a function as NtCreateFile and NtOpenFile. The preset function address replacing the original one may be set as required. In specific implementation, the address of the preset function MyNtCreateFile or another preset function may be used to replace a function address stored in the import table. This embodiment sets no limitation on the specific preset function address, and any function address that can be used to pass through the file filter driver is applicable.

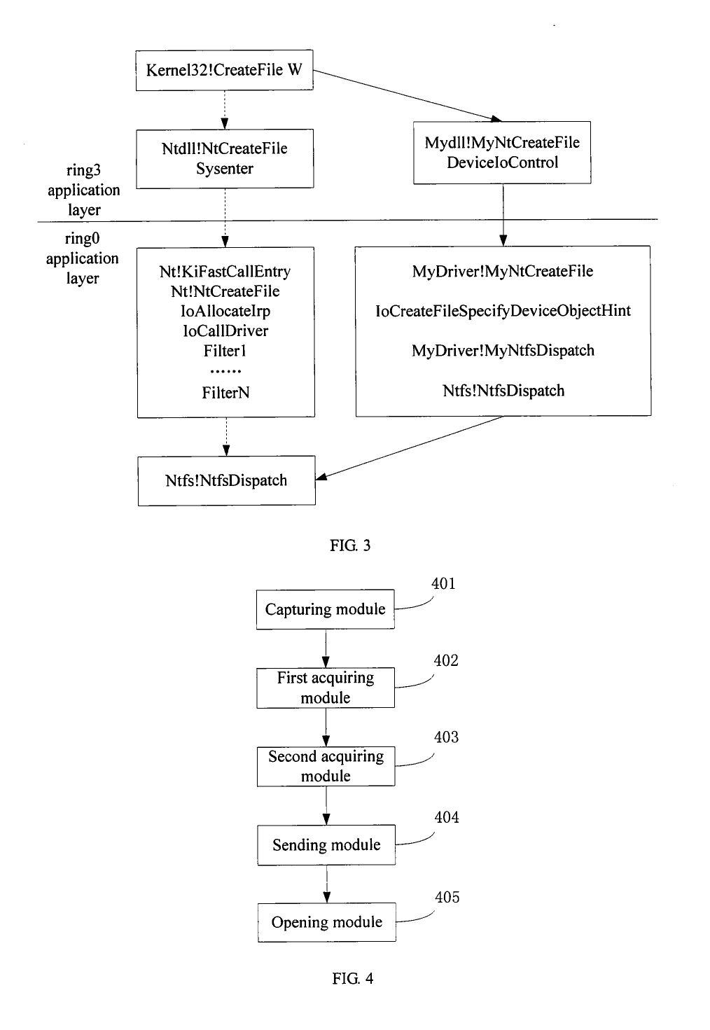

As illustrated in FIG. 3, after the replacement of the function address stored in the import table, the file opening process is modified from the one shown in the dotted arrows to the one shown in the solid arrows, thereby passing through the file filter driver that may exist in the original process.

It should be noted that when one file is opened multiple times or multiple files are opened concurrently, step 201 does not need to be performed repeatedly, and the system API function address recorded in the kernel32.dll import table only needs to be replaced once. After the replacement, each time the original system API function is called, the function corresponding to the address replacing the original one is actually called, thereby passing through the original file filter driver. Assuredly, if the preset function address needs to be re-set, the related step may be performed again to replace the function address stored in the import table with a new preset function address. This embodiment sets no limitation on whether to perform the step each time the file opening method is performed.

202: Capturing a file opening action, and recording a parameter corresponding to the file opening action.

With respect to this step, this embodiment sets no limitation on the manner of capturing the file opening action. The capturing of the file opening action may be implemented according to the conventional method, since the conventional file opening method may also involve the operation of capturing the file opening action.

This embodiment sets no limitation on the parameter corresponding to the file opening action. The parameter includes, but not limited to, a file name, a granted permission, or the like. Recording the parameter corresponding to the file opening action refers to storing the parameter corresponding to the file opening action into the memory such that the file opening operation is subsequently performed according to the recorded parameter.

203: Acquiring a corresponding original file system device object and a corresponding original file system distribution function address.

Specifically, the file system refers to a disk or partition for storing files, whereas the file system device object may be a specific disk or partition. Different files correspond to different file system device objects. For example, if a file to be opened is located in disk C, disk C may be used as a file system device object corresponding to the file. The file system distribution function is used to perform the file opening operation. For different file system device objects, a plurality of file system distribution functions may be called. When the file system device object receives a file opening request, the corresponding file system distribution function may be called. In this embodiment, with respect to the file system device object and file system distribution function that are captured and modified by the file filter driver, this embodiment defines the file system device object corresponding to the original file that is not modified by the file filter driver as the original file system device object. The file system distribution function called by the original file system device object is referred to as the original file system distribution function.

This embodiment sets no limitation on the manner of acquiring the original file system device object and the original file system distribution function address. In practice, a driver program for acquiring the original file system device object and the original file system distribution function address may be pre-written, and the original file system device object and the original file system distribution function address may be acquired by using the pre-written driver program.

Since the VPB structure records file system device objects, by using a pre-written driver program, the corresponding original file system device object may be searched for in the VPB structure recording file system device objects. In addition, since when the pre-written driver program is started in a BOOT manner, the information recorded in the system is unmodified and trusted information, the file system distribution function address acquired during starting of the driver program in the BOOT manner is the original file system distribution function address. Therefore, a pre-written driver program may be started in a BOOT manner, and the corresponding original file system distribution function address may be acquired by using the pre-written driver program.

204: Directly sending a file opening request to a file system where the original file system device object is located, and transferring the file opening request over the file system to an original file system distribution function corresponding to the original file system distribution function address.

Specifically, when the file opening request is directly sent to the file system where the original file system device object is located, this embodiment sets no limitation on the manner of sending the file opening request. During specific implementation, function IoCreateFileSpecifyDeviceObjectHint may be used, and the file opening request is directly sent to the file system where the original file system device object is located by using the original file system device object as a parameter.

The function IoCreateFileSpecifyDeviceObjectHint is an existing API function on the Windows system. By using this function, the file opening request can be directly sent to the file system where the original file system device object is located. After the file opening request is sent to the file system where the original file system device object is located, the original file system device object is triggered to call the corresponding original file system distribution function. In this way, the file system transfers the file opening request to the original file system distribution function corresponding to the original file system distribution function address, and the original file system distribution function performs the file opening operation, thereby avoiding the intermediate file filter driver.

205: Performing the file opening operation by using the original file system distribution function according to the preset function address replacing the original one and the recorded parameter.

In this step, when the original file system distribution function performs the file opening operation according to the preset function address replacing the original one, the original file opening process is modified. As illustrated in FIG. 3, the dotted arrows indicate the original file opening process, where the function NtCreateFile has been replaced with the function MyNtCreateFile, and the file opening process is modified from the one shown in the dotted arrows to the one shown in the solid arrows, thereby avoiding the file filter driver that may exist therein, and preventing such unnecessary operations as virus scanning on the file due to capturing of filter driver's access to the file. In this way, even if multiple types of antivirus software are installed, when a file is opened by using the method according to this embodiment, another type of antivirus software cannot detect the file opening action, and is not activated to perform virus scanning on the file, thereby preventing the problem about system compatibility, and the problem of increased system load.

In addition, the original file opening manner is accommodated when the file opening operation is performed by using the original file system distribution function according to the recorded parameter. For example, the parameter corresponding to the original file opening action indicates that the file has a read permission. In this case, during recording of the parameter and opening the file according to the parameter, the read permission of the file is maintained to keep consistent with the permission requirement specified in the original file opening method, thereby accommodating user's original requirement on file opening.

According to the method provided in this embodiment, a file opening action is captured, a file opening request is directly sent to a file system where an original file system device object is located, and a file opening operation is performed by using an original file system distribution function. This implements pass-through of a file filter driver, and thus reduces unnecessary operations of virus scanning each time a file is opened. In addition, when multiple types of antivirus software are installed, system load caused by scanning due to repeated opening of files is decreased, and the system compatibility is thus further improved.

This embodiment provides a file opening apparatus, where the apparatus is configured to perform the file opening method provided in the above-described embodiments. Referring to FIG. 4, the apparatus includes

a capturing module 401, configured to capture a file opening action;

a first acquiring module 402, configured to acquire a corresponding original file system device object after the capturing module 401 captures the file opening action;

a second acquiring module 403, configured to acquire a corresponding original file system distribution function address after the capturing module 401 captures the file opening action;

a sending module 404, configured to directly send a file opening request to a file system where the original file system device object acquired by the first acquiring module 402 is located, and transfer the file opening request to an original file system distribution function corresponding to the original file system distribution function address acquired by the second acquiring module 403; and

an opening module 405, configured to perform a file opening operation by using the original file system distribution function.

For details about the manner of capturing the file opening action by the capturing module 401, reference may be made to the related description of step 202 in the above-described embodiment. For details about the manner of acquiring the corresponding original file system device object by the first acquiring module 402, and the manner of acquiring the corresponding original file system distribution function address by the second acquiring module 403, reference may be made to the related description of step 203 in the above-described embodiment. For details about the manner of directly sending by the sending module 404 the file opening request to the file system where the original file system device object acquired by the first acquiring module 402 is located, and transferring the file opening request to the original file system distribution function corresponding to the original file system distribution function address acquired by the second acquiring module 403, reference may be made to the related description of step 204 in the above-described embodiment. For details of the manner of performing the file opening operation by the opening module 405 by using the original file system distribution function, reference may be made to the related description of step 205 in the above-described embodiment. These details are not described herein any further.

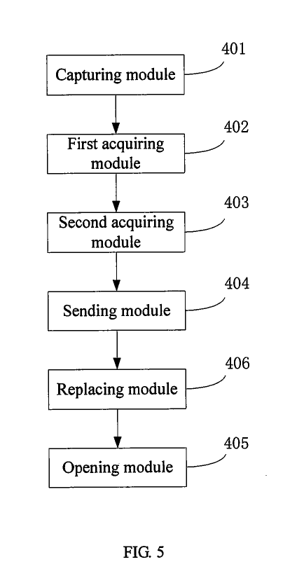

Furthermore, with reference to the description in step 201 in the above-described embodiment referring to FIG. 5, the apparatus further includes:

a replacing module 406, configured to search for an import table of 32-bit dynamic link library files and replace a function address stored in the import table with a preset function address;

where correspondingly, the opening module 405 is specifically configured to perform the file opening operation by using the original file system distribution function according to the preset function address replacing the original one by the replacing module 406.

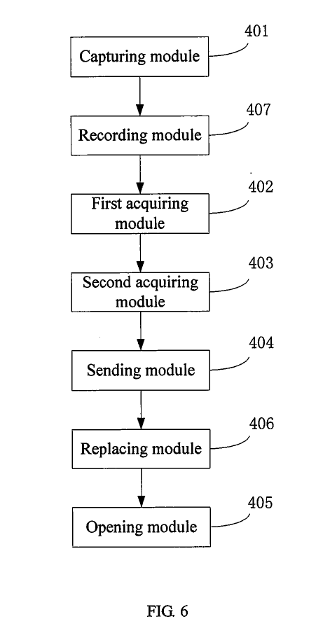

Furthermore, with reference to the description in step 202 in the above-described embodiment, referring to FIG. 6, the apparatus further includes:

a recording module 407, configured to record a parameter corresponding to the file opening action captured by the capturing module 401; and

where correspondingly, the opening module 405 is specifically configured to perform the file opening operation by using the original file system distribution function according to the parameter recorded by the recording module 407.

The first acquiring module 402 is specifically configured to, by using a pre-written driver program, search for the corresponding original file system device object in a VPB structure recording file system device objects.

The second acquiring module 403 is specifically configured to start a pre-written driver program in a BOOT manner, and acquire the corresponding original file system distribution function address by using the pre-written driver program.

The sending module 404 is specifically configured to use function IoCreateFileSpecifyDeviceObjectHint, and by using the original file system device object as a parameter, directly send the file opening request to the file system where the original file system device object is located.

According to the apparatus provided in this embodiment, a file opening action is captured, a file opening request is directly sent to a file system where an original file system device object is located, and a file opening operation is performed by using an original file system distribution function. This implements pass-through of a file filter driver, and thus reduces unnecessary operations of virus scanning each time a file is opened. In addition, when multiple types of antivirus software are installed, system load caused by scanning due to repeated opening of files is decreased, and the system compatibility is thus further improved.

This embodiment provides a terminal, where the terminal includes the file opening apparatus according to the above-described embodiment.

The terminal may be specifically a mobile terminal, or may be a PC or other terminals. This embodiment sets no limitation on the specific form of the terminal product.

According to the apparatus provided in this embodiment, a file opening action is captured by using a file opening apparatus, a file opening request is directly sent to a file system where an original file system device object is located, and a file opening operation is performed by using an original file system distribution function. This implements pass-through of a file filter driver, and thus reduces unnecessary operations of virus scanning each time a file is opened. In addition, when multiple types of antivirus software are installed, system load caused by scanning due to repeated opening of files is decreased, and the system compatibility is thus further improved.

It should be noted that, during file opening by the file opening apparatus provided in the above embodiment, the apparatus is described by only using division of the above functional modules as an example. In practice, the functions may be assigned to different functional modules for implementation as required. To be specific, in terms of the internal structure, the apparatus is divided into different functional modules to implement all or part of the above-described functions. In addition, the file opening apparatus and terminal provided in the above embodiments are based on the same inventive concept as the embodiment illustrating the file opening method. The specific implementation is elaborated in the method embodiments, which is not described herein any further.

A person skilled in the art may clearly understand that the described apparatus embodiments are merely exemplary. Specifically, the unit/module division is merely logical function division and can be other divisions in actual implementation. For example, various function units/modules in the embodiments of the present disclosure may be integrated in a processing unit/module, or physically independent units/modules; or two or more than two function units/modules may be integrated into a unit/module. The integrated unit/module may be implemented in a form of hardware, or may be implemented in a form of a software functional unit/module.

A person skilled in the art should understand that all or part of steps of the preceding methods may be implemented by hardware or hardware following instructions of programs. The programs may be stored in a non-transitory computer-readable storage medium, and may be executed by at least one processor. The storage medium may be a read only memory, a magnetic disk, or a compact disc-read only memory.

Described above are merely preferred embodiments of the present disclosure, but are not intended to limit the present disclosure. Any modification, equivalent replacement, or improvement made without departing from the spirit and principle of the present disclosure should fall within the protection scope of the present disclosure.

1. A file opening method, comprising:
capturing a file opening action, and acquiring a corresponding original file system device object and a corresponding original file system distribution function address; and
directly sending a file opening request to a file system where the original file system device object is located, transferring the file opening request over the file system to an original file system distribution function corresponding to the original file system distribution function address, and performing a file opening operation by using the original file system distribution function.

2. The method according to claim 1, wherein prior to the capturing a file opening action, the method further comprises:
searching for an import table of 32-bit dynamic link library files and replacing a function address stored in the import table with a preset function address;
correspondingly, the performing a file opening operation by using the original file system distribution function specifically comprises:
performing the file opening operation by using the original file system distribution function according to the preset function address replacing the original one.

3. The method according to claim 1, wherein after the capturing a file opening action, the method further comprises:
recording a parameter corresponding to the file opening action;
wherein correspondingly, the performing a file opening operation by using the original file system distribution function specifically comprises:
performing the file opening operation by using the original file system distribution function according to the recorded parameter.

4. The method according to claim 1, wherein the acquiring a corresponding original file system device object specifically comprises:
by using a pre-written driver program, searching for the corresponding original file system device object in a volume parameter block (VPB) structure recording file system device objects.

5. The method according to claim 1, wherein the acquiring a corresponding original file system distribution function address specifically comprises:
starting a pre-written driver program in a BOOT manner, and acquiring the corresponding original file system distribution function address by using the pre-written driver program.

6. The method according to claim 1, wherein the directly sending a file opening request to a file system where the original file system device object is located specifically comprises:
using function IoCreateFileSpecifyDeviceObjectHint, and by using the original file system device object as a parameter, directly sending the file opening request to the file system where the original file system device object is located.

7. A file opening apparatus, comprising:
a capturing module, configured to capture a file opening action;
a first acquiring module, configured to acquire a corresponding original file system device object after the capturing module captures the file opening action;
a second acquiring module, configured to acquire a corresponding original file system distribution function address after the capturing module captures the file opening action;
a sending module, configured to directly send a file opening request to a file system where the original file system device object acquired by the first acquiring module is located, and transfer the file opening request over the file system to an original file system distribution function corresponding to the original file system distribution function address acquired by the second acquiring module; and
an opening module, configured to perform a file opening operation by using the original file system distribution function.

8. The apparatus according to claim 7, further comprising:
a replacing module, configured to search for an import table of 32-bit dynamic link library files and replace a function address stored in the import table with a preset function address;
wherein correspondingly, the opening module is specifically configured to perform the file opening operation by using the original file system distribution function according to the preset function address replacing the original one by the replacing module.

9. The apparatus according to claim 7, further comprising:
a recording module, configured to record a parameter corresponding to the file opening action captured by the capturing module; and
wherein correspondingly, the opening module is specifically configured to perform the file opening operation by using the original file system distribution function according to the parameter recorded by the recording module.

10. The apparatus according to claim 7, wherein the first acquiring module is specifically configured to, by using a pre-written driver program, search for the corresponding original file system device object in a volume parameter block (VPB) structure recording file system device objects.

11. The apparatus according to claim 7, wherein the second acquiring module is specifically configured to start a pre-written driver program in a BOOT manner, and acquire the corresponding original file system distribution function address by using the pre-written driver program.

12. The apparatus according to claim 7, wherein the sending module is specifically configured to use function IoCreateFileSpecifyDeviceObjectHint, and by using the original file system device object as a parameter, directly send the file opening request to the file system where the original file system device object is located.

13. (canceled)

14. A terminal, comprising a file opening apparatus,
the file opening apparatus comprising:
a capturing module, configured to capture a file opening action;
a first acquiring module, configured to acquire a corresponding original file system device object after the capturing module captures the file opening action;
a second acquiring module, configured to acquire a corresponding original file system distribution function address after the capturing module captures the file opening action;
a sending module, configured to directly send a file opening request to a file system where the original file system device object acquired by the first acquiring module is located, and transfer the file opening request over the file system to an original file system distribution function corresponding to the original file system distribution function address acquired by the second acquiring module; and
an opening module, configured to perform a file opening operation by using the original file system distribution function.

15. The terminal according to claim 14, the file opening apparatus further comprising:
a replacing module, configured to search for an import table of 32-bit dynamic link library files and replace a function address stored in the import table with a preset function address;
wherein correspondingly, the opening module is specifically configured to perform the file opening operation by using the original file system distribution function according to the preset function address replacing the original one by the replacing module.

16. The terminal according to claim 14, the file opening apparatus further comprising:
a recording module, configured to record a parameter corresponding to the file opening action captured by the capturing module; and
wherein correspondingly, the opening module is specifically configured to perform the file opening operation by using the original file system distribution function according to the parameter recorded by the recording module.

17. The terminal according to claim 14, wherein the first acquiring module is specifically configured to, by using a pre-written driver program, search for the corresponding original file system device object in a volume parameter block (VPB) structure recording file system device objects.

18. The terminal according to claim 14, wherein the second acquiring module is specifically configured to start a pre-written driver program in a BOOT manner, and acquire the corresponding original file system distribution function address by using the pre-written driver program.

19. The terminal according to claim 14, wherein the sending module is specifically configured to use function IoCreateFileSpecifyDeviceObjectHint, and by using the original file system device object as a parameter, directly send the file opening request to the file system where the original file system device object is located.
